(19) United States
(12) Patent Application Publication
(10) Pub. No.: US 2002/0040396 A1
(43) Pub. Date: Apr. 4, 2002

(54) Management device and managed device in policy based management system

(75) Inventors: Kiyohito Yoshihara, Saitama (JP); Hiroki Horiuchi, Saitama (JP)

Correspondence Address: ARMSTRONG,WESTERMAN & HATTORI, LLP, 1725 K STREET, NW., SUITE 1000, WASHINGTON, DC, 20006, US

(73) Assignee: KDDI Corporation, Tokyo (JP)

(21) Appl. No.: 09/963,705

(22) Filed: Sep. 27, 2001

(30) Foreign Application Priority Data
Sep. 29, 2000 (JP) 2000-300817

(51) Int. Cl. G06F 15/173

(52) U.S. Cl. 709/225

(57) ABSTRACT

Provided is a policy based management system such that a policy enforced by each router (a managed device) in a network can be optimally adjusted in real time according to a traffic usage. At a managed device 3 in a network NT, there is provided: a policy enforcement means 31 for enforcing policy information distributed from a management device 2, thereby controlling a traffic; a policy evaluation means 32 for evaluating a policy based on policy evaluation information distributed from the management device 2; and a policy adjustment means 33 for dynamically adjusting the policy based on the policy adjustment information distributed from the management device 2 and the evaluation result caused by said evaluation means.

### BACKGROUND OF THE INVENTION

1. Field of the Invention

The present invention relates to a management device and a managed device in a policy based management system for managing policy information by the management device, and distributing the policy information to the managed device in a network, thereby controlling a traffic. More particularly, the present invention relates to a management device and a managed device in a policy based management system for evaluating an enforcement effect of a policy in the managed device so as to dynamically adjust the policy according to a utilization state of a network based on the evaluation result.

2. Description of the Related Art

In E-commerce or corporate businesses or the like, as Internet is commercially available, there is a growing need to ensure a required communication Quality of Services (QoS) for each user or application in order to maximize profit caused by efficient use of limited network resources.

On the other hand, in order to reduce a burden on a network manager by managing the communication quality on per user and application bases, there becomes more popular policy based management in which policy information is registered as the communication quality for each user or application in a policy server, and policy information is managed to be distributed from the policy server to dispersed network devices. According to such policy based management, it is possible to set policy information to such dispersed network devices without any inconsistency, and change of policy information is facilitated.

There is Differentiated Services (hereinafter, referred to as DiffServ) as one of the communication quality assurance mechanism of Internet in which standardization is accelerated in IETF (Internet Engineering Task Force). In this DiffServ, a policy for assuring a communication quality customized for each user or application is managed to be distributed from a management device to a managed device in a policy based management system.

FIG. 8 is a view showing a configuration of a DiffServ compatible network. A PHB (per-hop behavior) that is an identifier representative of QoS is assigned to each traffic. Each router 90 transfers an input traffic to a next router with QoS according to the PHB. In each IP packet, a DSCP (Differentiated Services Code Point) of 6 bit length is assigned to a DS (Differentiated Services) field instead of the PHB. Each router associates PHB with DSCP.

The interface (I/F) of each router 90 is discriminated into an edge I/F 91 connected to a transmission/receiving node and a core I/F 92 connected to another router. The edge I/F 91 is further discriminated into an ingress I/F 91 (in) connected to a transmission node and an engress I/F 91 (en) connected to a receiving node. A router comprising the edge I/F 91 is called an edge router 90 (E), and a router specific to a core I/F 92 is called a core router 90 (C).

An IP packet first passing through the above DiffServ compatible router is classified into some QoS class according to the value of an IP address or port number of the transmission/receiving node. In an edge router 90 (E), the DSCP value is assigned to that DS field. A core router 90 (C) classifies each IP packet based on the DSCP value, carries out communication quality control, and transfers such each packet to a next router. The DSCP value is cleared in an engress I/F 91 (en) of the edge router 90 (E).

A classifier is employed for the purpose of classification of the IP packet. The classifier of the ingress I/F 91 (in) is called MF (multi-field) classifier, and each IP packet is classified based on five parameters such as the transmission/receiving IP address, transmission/receiving port number, and IP protocol version. The classifier of the core I/P 92 is called a BA (Behavior Aggregate) classifier, and each IP packet is classified by the DSCP value.

In policy based network management, in the case where there occurs an environmental change such as the number of users, an increased network traffic or deployment of a new application, an earlier distributed policy does not always function efficiently. There can occur a case in which a network resource is consumed wastefully because bandwidths are overestimated relevant to the existing policy or conversely a case in which a desired service cannot be provided because bandwidth is underestimated relevant to the policy.

Therefore, in policy based network management, it is desirable that (1) determination of a policy, (2) distribution of the determined policy and its enforcement, (3) evaluation of the policy under enforcement, and (4) adjustment of the policy based on the evaluation result be repeatedly carried out in real time.

In contrast, conventionally, a network manager always supervises a traffic over a network, and if the existing policy does not conform to an actual traffic, management information required for adjustment of policy is additionally acquired, whereby a policy has been reset based on the acquired management information. However, since network environment dynamically changes continuously, it has been difficult to optimally adjust a policy in real time according to a network utilization state with the above described adjustment method.

### SUMMARY OF THE INVENTION

The present invention has been made in order to solve the foregoing problem. An object of the present invention is to provide a management device and a managed device in a policy based management system capable of optimally adjusting a policy enforced by each router in a network in real time according to a traffic state.

In order to achieve the foregoing object, there is provided a management device and a managed device in a policy based management system for managing policy information by the management device, and distributing the policy information to the managed device, thereby controlling a traffic, wherein:

(1) the management device comprises: a policy information input means for inputting policy information; a policy evaluation information input means for inputting evaluation information for evaluating an enforcement effect of a policy in the managed device; a policy adjustment information input means for inputting adjustment information for dynamically adjusting a policy enforced by the managed device; and a distribution means for distributing the inputted policy information, policy evaluation information, and policy adjustment information to the managed device, and

(2) the managed device comprises a policy enforcement means for enforcement of policy information distributed from the management device, thereby controlling a traffic; a policy evaluation means for evaluating a policy under operation based on policy evaluation information distributed from the management device; and a policy adjustment means for dynamically adjusting a policy under operation based on the policy adjustment information distributed from the management device and the evaluation result obtained by evaluation means.

According to the above features, a policy operated to be distributed to each managed device is dynamically adjusted according to a traffic status. Thus, overestimation or underestimation of network resources such as bandwidth is alleviated, enabling its efficient use.

### BRIEF DESCRIPTION OF THE DRAWINGS

FIG. 1 is a functional block diagram depicting a configuration of a policy based management system according to the present invention;

FIG. 2 is a block diagram depicting a configuration of essential portions of an managed device;

FIG. 3 is a view schematically expressing the contents of each of policies A, B, and C;

FIG. 4 is a view schematically expressing the contents of each profile;

FIG. 5 is a view showing a display example of a policy input screen when the policy A is set;

FIG. 6 is a view showing a display example of a policy input screen when the policy B is set;

FIG. 7 is a view showing a display example of a policy input screen when the policy C is set; and

FIG. 8 is a view showing a configuration of a DiffServ compatible network.

### DETAILED DESCRIPTION OF THE PREFERRED EMBODIMENT

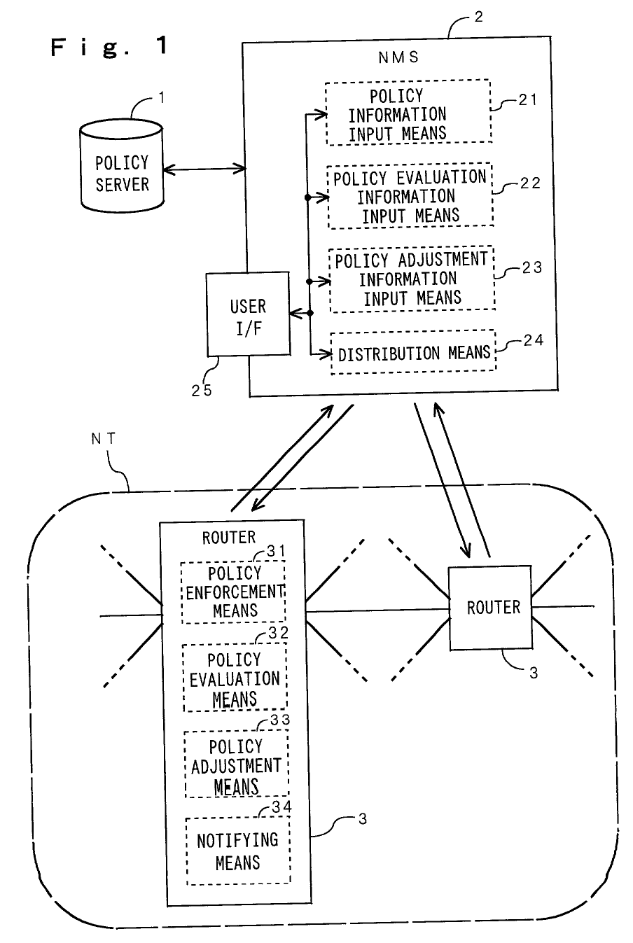

Hereinafter, the present invention will be described in detail with reference to the accompanying drawings. FIG. 1 is a functional block diagram depicting a configuration of a policy based management system according to the present invention. This policy based management system includes: a plurality of routers 3 that are managed device for controlling a traffic in a network NT; a policy server 1 for storing policy information; and a network management system (NMS) 2 that is an management device for generating policy information and distributing the generated information to each router 3.

The management system 2 includes: a policy information input means 21 for inputting a policy enforced in each router 3; a policy evaluation information input means 22 for inputting evaluation information for evaluating an enforcement effect of the policy in each router 3; a policy adjustment information input means 23 for inputting adjustment information for dynamically adjusting a policy operated in the router 3 based on the estimation result; and a distribution means 24 for distributing to each router 3 an management script having described therein the input policy information, policy evaluation information, and policy adjustment information.

The policy information, policy evaluation information, and policy adjustment information are input by an operator via a proper man-machine I/F 25 that includes an operating section and a display section or the like.

The routers 3 each include: a policy enforcement means 31 for operating policy information distributed from the management system 2,thereby controlling a traffic; a policy evaluation means 32 for evaluating an enforcement effect of a policy under operation based on policy evaluation information distributed from the management system 2; a policy adjustment means 33 for adjusting a policy under operation based on the policy adjustment information distributed from the management system 2 and the evaluation result obtained by the evaluation means; and a notifying means 34 for indirectly notifying information via an management system 2 and directly notifying information without intervening the management system 2.

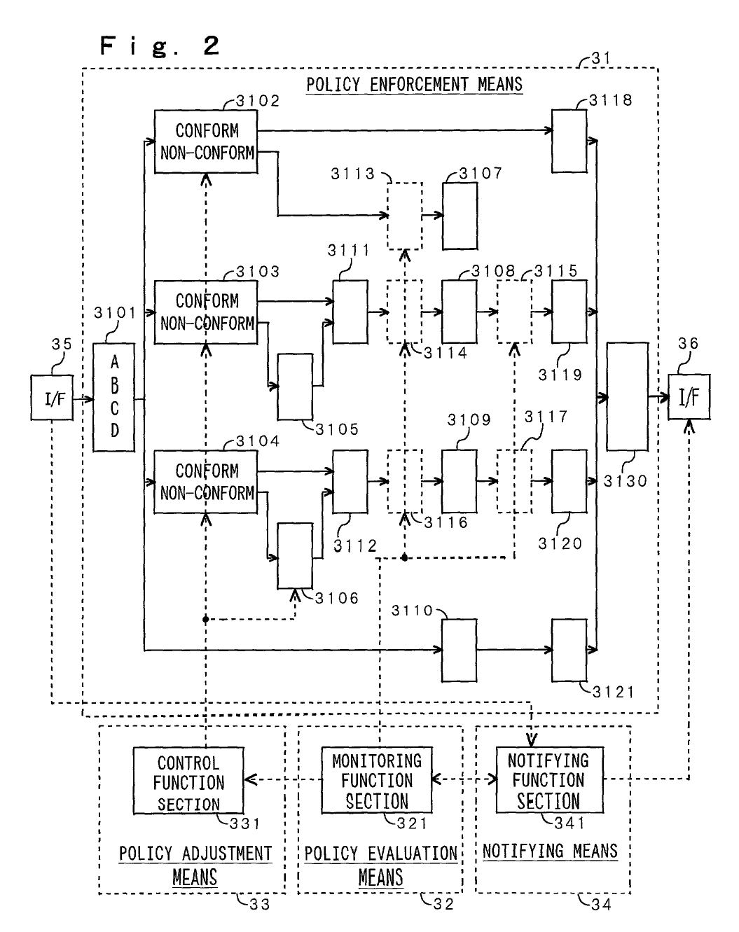

FIG. 2 is a block diagram specifically depicting a configuration of essential portions of the router 3.

In the policy operation means 31, a classfier 3101 classifies an IP packet input via an input I/F 35 into a QoS class based on parameters such as transmission IP address, receiving IP address, transmission port number, receiving port number, and IP protocol version or the DSCP value (in the case of an MF classifier) or based on the DSCP value (in the case of a BA classifier).

Meters 3102, 3103, and 3104 judge whether or not a traffic conforms to a transfer rate or a burst size designated in advance based on policy information, and switches an output destination of each traffic based on the result. Markers 3105 and 3106 set or replace the DSCP value, and change a QoS class of the traffic (or packet). Multiplexers 3111 and 3112 merge a plurality of traffics.

Counters 3113 to 3117 count the number of passing IP packets or the number of IP packet bytes. An unconditional dropper 3107 discards a packet unconditionally. Selective droppers 3108, 3109, and 3110 discards selectively a packet under a predetermined condition. Queues 3118 to 3121 queue an input IP packet. A scheduler 3130 reads out packets from such queues 3118 to 3121 each in accordance with a predetermined sequence and priority, and outputs them to an output I/F 36.

A supervising function section 321 of the policy evaluation means 32 detects the number of discarded packets or the like based on the count value of each of the counters 3113 to 3117, and evaluates an enforcement effect of a policy under operation. A control function section 331 of the policy adjustment means 33 adjusts properly a policy under operation based on the evaluation result obtained by the policy evaluation means 32. A notifying function section 341 of the notifying means 34 notifies the evaluation result concerning the enforcement effect to another router 3, and notifies the evaluation result notified from another router to the control function section 331 of the policy adjustment means. In the case where the evaluation result is notified from another router as well, the control function section 331 properly adjusts a policy based on the evaluation result in the same way as the above.

Now, a method for registering policy information, policy evaluation information, and policy adjustment information relevant to the above described each routers 3 will be described here.

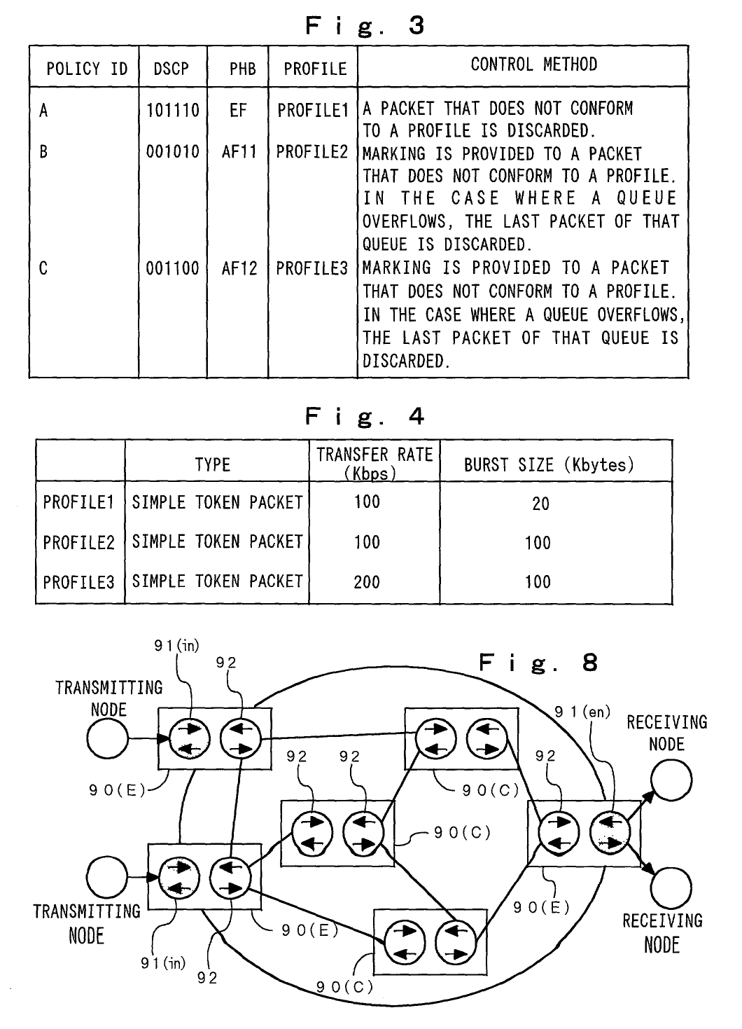

The present embodiment describes an example when an operator registers four types of policies A, B, C, and D from a man-machine I/F 25 of the management system 2. The contents of these policies are as shown FIG. 3. A policy D is handled as a best effort (BE) traffic that does not guarantee a communication quality, and the profile of each of the policies A, B, and C is as shown in FIG. 4.

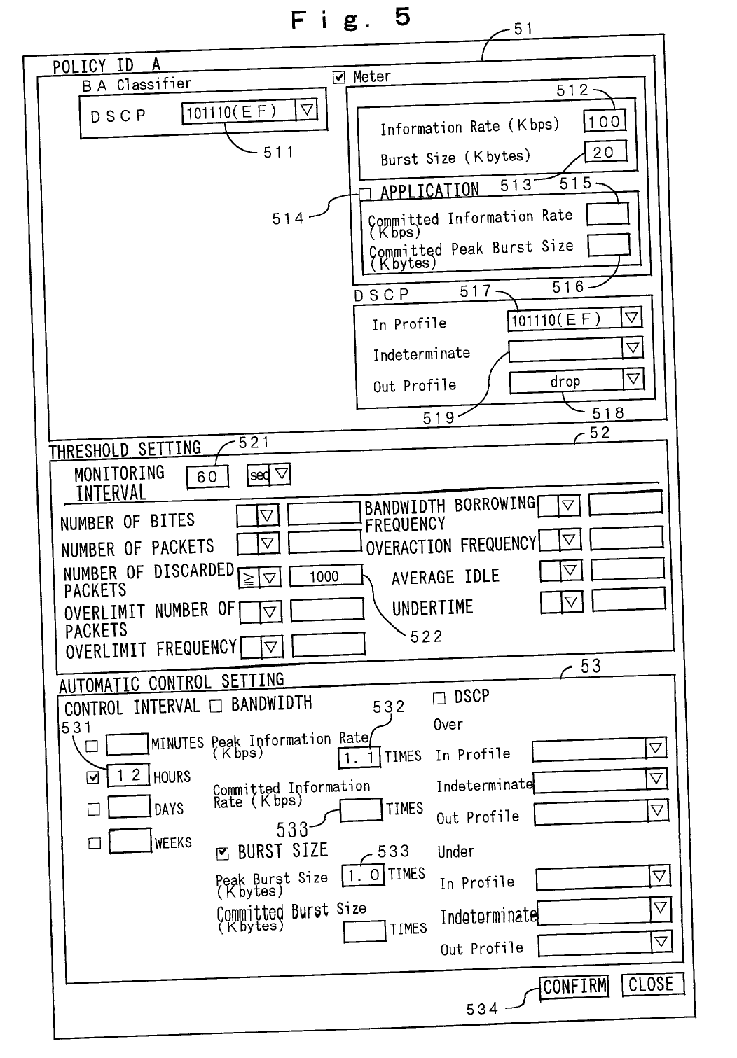

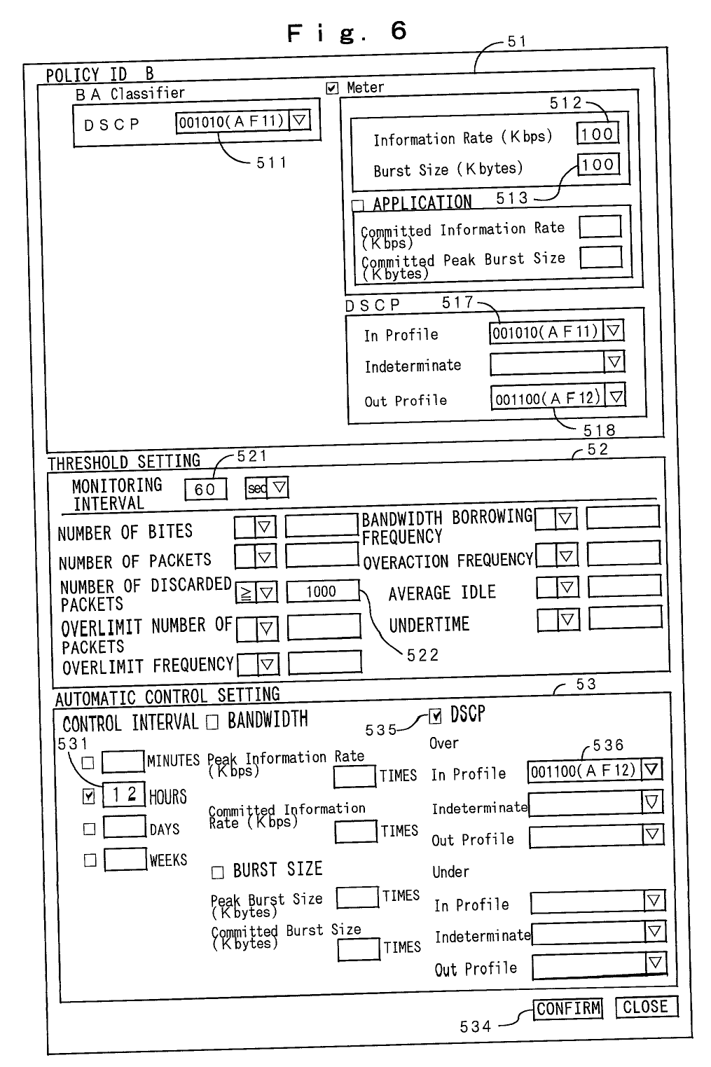

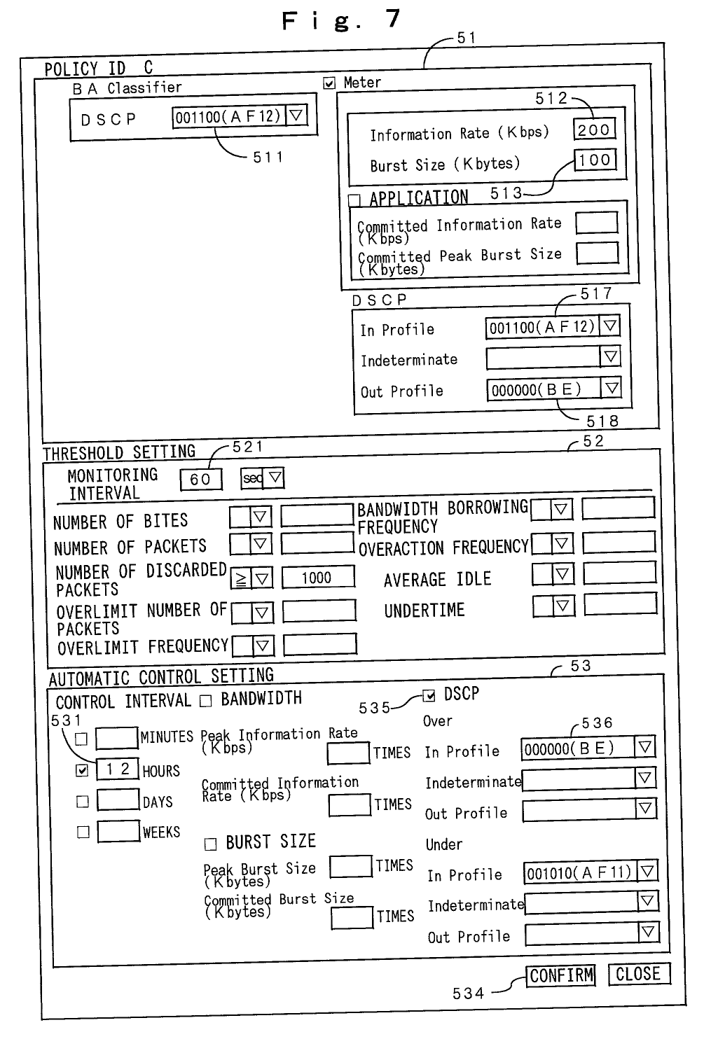

FIG. 5, FIG. 6, and FIG. 7 are views each showing an example of a policy setting screen displayed on the operating screen of the man-machine I/F 25 of an management system 2. These figures each shows an input example of each of the policies A, B, and C.

The policy setting screen includes: a policy information input region 51 for primarily inputting policy information; a threshold setting region 52 for primarily inputting policy evaluation information; and an automatic control setting region 53 for primarily inputting policy adjustment information for dynamically adjusting policy information in a router 3.

1. Setting Policy A (FIG. 5)

<1>Inputting Policy Information

As shown in FIG. 3, in the policy A, PHB (Expedited Forwarding Per-Hop-Behavior) is an EF (Expedited Forwarding PHB: QoA that does not permit a delay). Thus, a value “101110” of DSCP (Differentiated Service Code Point: Priority information) is registered in a DSCP window 511.

As shown in FIG. 4, in a profile 1 of the policy A, the threshold [Kbps] of a transfer rate (Information Rate) is set to “100”, and the threshold [Kbps] of a burst size (Burst Size) [Kbytes] is set to “20”. Thus, “100” is registered in a transfer rate threshold window 512, and “20” is registered in a burst size threshold window 513, respectively.

In the case where it is determined whether or not a packet conforms to a profile by employing “Single Rate Color Marker” or “Two Rate Three Color Marker” or the like, a application check box 514 is further checked, and desired values are set in a Committed Information Rate window 515 and a Committed Burst Size window 516.

As shown in FIG. 4, in this example, a “simple token packet” for determining a profile by using one set (transfer rate and burst size) is employed. Thus, the windows 515 and 516 each are kept unregistered without checking the application check box 514.

In an “In Profile” window 517 of the DSCP, “101110” (EF)” is registered as a value when one DSCP value of a packet that conforms to a profile is replaced with another DSCP value. In an “Out Profile” window 518, “drop”, i.e., “discard” is registered as a value when one DSCP value of a packet that does not conform to a profile is replaced with another DSCP value.

In the “Single Rate Three Color Marker” or “Two Rate Three Color Marker” described previously, a value when one DSCP value of a packet judged as semi-conforming is replaced with another value is registered in an “Intermediate” window 519.

<2>Inputting Policy Evaluation Information

In the present embodiment, as information for evaluating an enforcement effect of a policy under operation, thresholds concerning monitoring items such as the number of receiving packets, the number of receiving bytes, and the number of discarded packets are input together with its monitoring interval.

In the case where an out-of-threshold notification is issued to a policy adjustment means 33 if the number of discarded packets per 60 seconds exceeds 1000, in the policy A, 60 [seconds] is registered in a “monitoring interval” window 521, and “1000 or more” is registered in a “number of discarded packets” window 522. In this manner, in the policy A, if the number of discarded packet exceeds 1000, automatic policy adjustment is driven by the policy adjustment means 33.

In the case where the thresholds of a plurality of supervisory items are specified at the same time, if at least one monitoring item exceeds the threshold, the out-of-threshold” notification is issued. Only in the case where all the monitoring items exceed the thresholds, it is possible to issue the notification and to define a logical conditional formula that consists of these monitoring items, thereby issuing the notification based on the logic condition.

<3>Inputting Policy Adjustment Information

In the present embodiment, apart from the case where the out-of-threshold has been notified, even in the case where no “out-of-threshold” is issued, an enforcement effect of the policy is evaluated for each predetermined control interval so as to automatically adjust a policy.

That is, in the present embodiment, unless the number of discarded packets for 60 seconds exceeds 1000, the out-of-threshold is not issued. However, for example, even if the number of discarded packets for 60 seconds is about 500, it is desirable that a network resource such as bandwidth to be set as a policy be increased. Conversely, in the case where the number of discarded packets is 0, it is predicted that a policy quality is excessive. Thus, it is desirable that the network resources assigned by the policy is reduced.

In the present embodiment, in order to set a predetermine control interval, and then, adjust dynamically a policy according to a traffic in the control interval, a control interval for adjusting a policy in real time according to a network utilization state, a transfer rate assigned to the policy A after adjusted, a burst size, and a replacement DSCP value are specified.

FIG. 5 shows an example when the current transfer rate threshold (100) and burst size threshold (20) are adjusted to 1.1 times of the maximum transfer rate monitored within 12 hours and to 1.0 of the maximum burst size. In the figure, “12” [hours] is set at a control interval window 531, “1.1” times is set at a Peak Information Rate window 532, and “1.0” time is set at a Peak Burst Size” window 533, respectively. In this manner, in the policy A of the present embodiment, even if no “out-of-threshold” occurs, the transfer rate thresholds and burst size thresholds are dynamically adjusted according to a network utilization state every 12 hours.

When each information setting is terminated as described above, an “CONFIRM” button is depressed, and the input operation is terminated. A distribution means 24 distributes each item of the inputted information to each router 3.

2. Setting Policy B (FIG. 6)

<1>Inputting Policy Information

As shown in FIG. 3, in the policy B, a PHB is set to AF11 (Assured Forwarding Group: A permissible packet loss rate at end-to-end is reduced), and thus, the DSCP value “001010” corresponding to AF11 is registered in the DSCP window 511.

As shown in FIG. 4, in a profile 2 of the policy B, a transfer rate threshold (Information Rate) [Kbps] is “100” and a burst size threshold (Burst Size) [Kbytes] is “100”. Thus, “100” is registered in a transfer rate threshold window 512, and “100” is registered in a burst size threshold window 513. The Committed Information Rate and Committed Burst Size are specified as described previously.

In an “In Profile” window 517 of the DSCP, “001010” (AF11) is registered as a value for a packet having the DSCP value conforming to a profile is replaced with another DSCP value. In an “Out Profile” window 518, “001100” (AF12) is registered as a value for a packet having the DSCP value not conforming to a profile is replaced with another DSCP value.

That is, in the policy B of the present embodiment, the DSCP value of a packet that conforms to a profile is not changed. For a nonconforming packet, its DSCP value is updated to “001100 (AF12)”, and the transmission priority is degraded.

<2>Inputting Policy Evaluation Information

A description is omitted here because it is similar to that of policy A.

<3>Inputting Policy Adjustment Information

In the present embodiment, in the case where an out-of-threshold is detected (Over) within 12 hours of a control interval, an adjustment is made to replace the DSCP value of a packet (In Profile) that does not exceed the transfer rate threshold (100 Kbps here in this case) with “001100 (AF12)”, and then, degraded the transmission priority. Therefore, a checkbox 535 of the “DSCP” is checked, and “001100” (AF12) is registered in an “In Profile” window 536.

In FIG. 6, although not entered, an adjustment value if no out-of-threshold is detected within 12 hours of a control cycle is registered in each field following “Under”.

3. Setting Policy C (FIG. 7)

<1>Inputting Policy Information

As shown in FIG. 3, in the policy C, a PHB is set to AF12 (that is lower than AF11 in priority). Thus, the value “001100” of the DSCP that corresponds to AF12 is registered in a DSCP window 511.

As shown in FIG. 4, in a profile 3 of the policy C, a transfer rate threshold (Information Rate) [Kbps] is “200”, a burst size threshold (Burst Size) [Kbytes] is “100”. Thus, “200” is registered in a transfer rate threshold window 512, and “100” is registered in a burst size threshold window 513, respectively. The Committed Information Rate and Committed Burst Size are specified as described previously.

In an “In Profile” window 517 of the DSCP, “001100” (AF12) is registered as a value for a packet having the DSCP conforming to a profile is replaced with another DSCP value.

In an “Out Profile” window 518, “1000000” (BE: Best Effort) is registered as a value for a packet having the DSCP not conforming to a profile is replaced with another DSCP value.

That is, in the policy C of the present embodiment, the DSCP value of a packet that conforms to a profile is not changed. A nonconforming packet is adjusted so as to be handled as a general Internet traffic in which bandwidth control or priority control is not effected at all.

<2>Inputting Policy Evaluation Information

A description is omitted here because it is similar to those of policy A and policy B.

<3>Inputting Policy Adjustment Information

In the present embodiment, in the case (Over) where an out-of-threshold” is detected within 12 hours of a control interval, the DSCP value of a packet (In Profile) that does not exceed the transfer rate threshold (200 Kbps here in this case) is changed to “000000 (BE)”, and the packet is not targeted for priority control. Conversely, in the case (Under) where an out-of-threshold is not detected within 12 hours of a control interval, an adjustment is made to change the DSCP value of a packet that conforms (In Profile) to a profile to “001010” (AF11), and then, the transmission priority of the packet is promoted.

Therefore, a check box 535 of the “DSCP” is checked, “000000” (BE) is registered in an “In Profile” window 536 of “Over”, and “001010” (AF11) is registered in an “In Profile” window 537 of “Under”.

4. Determining Policy D

All packets having a DSCP other than those determined in policies A, B, and C are handled as a “best effort” traffic. Hereinafter, this is expressed as policy D.

The policy information, policy evaluation information, and policy adjustment information input as above mentioned, are distributed to each router 3 in accordance with protocols such as COPS (Common Open Policy Service), SNMP (Simple Network Management Protocol), or CLI (Command Line Interface), for example.

In each router 3, policy information is registered in each of the meters 3102, 3103, and 3104 and each of the multiplexers 3105 and 3106 of a policy operation means 31, policy evaluation information is registered in a policy evaluation means 32, and policy adjustment information is registered in a policy adjustment means 33.

As has been described above, when each information is set, and a policy is enforced by the policy enforcement means 31, a packet to which the policy A is applied is distributed from a classifier 3101 to a meter 3102. The meter 3102 transfers all the packets to a queue 3118 unless the inputted packet transfer rate exceeds 100 [Kbps], and the burst size exceeds 20 [Kbytes]. The packets stored in the queue 3118 are read out from a scheduler 3130, and is transferred to a next stage via an output communication I/F 36.

In contrast, if the transfer rate exceeds 100 [Kbps] or if the burst size exceeds 20 [Kbytes], the meter 3102 distributes an excess packet to a counter 3113. All the packets counted by the counter 3113 are discarded in an unconditional dropper 3107.

A packet to which policy B is applied is distributed from the classifier 3101 to the meter 3103. The meter 3103 distributes an input packet to the multiplexer 3111 unless the transfer rate of the input packet exceeds 100 [Kbps], and the burst size exceeds 100 [Kbytes]. Otherwise, the meter distributes the packet to a marker 3105. The marker 3105 converts the DSCP value (001010) registered in the DS of that packet into (001100), and degraded the priority.

The multiplexer 3111 gathers packets distributed from the meter 3103 and marker 3105 with each other, and transfers the gathered packets to a dropper 3108 via a counter 3114. The dropper 3108 discards a packet if a queue length is longer than a predetermined value. The packet that has been not discarded by the dropper 3108 is transferred to a queue 3118 via the counter 3115. The counters 3114 and 3115 count the number of packets before and after the dropper 3108. Thus, a difference between these count values represents the number of packets discarded by the dropper 3108.

For the policy C, a configuration of a dropper 3109 is different from that of the dropper 3108. That is, the dropper 3109 of the policy C is merely different from the dropper 3108 in that the former discards more packers than the latter, and is all the same in other enforcement. A duplicate description is omitted here.

A packet to which policy D is applied is distributed from the classifier 3101 to a dropper 3110. The dropper 3110 discards a packet of its queue length is longer than a predetermined value. The other packets are outputted to a queue 3121.

When each policy is enforced as described above, a monitoring function section 321 detects the count value of each counter at the specified monitoring interval, calculates the number of discarded packets, and evaluates the application effect of each policy based on the calculation result.

If the count value of the counter 3113 for counting the number of packets discarded after the policy A has been applied, for example, exceeds 1000, the montogig function section 321 notifies the fact to instruct a control function section 331 to make a policy adjustment and to instruct a control function section 331 of another router to make a policy adjustment via a notifying function section 341.

The control function section sets the already registered values to the meter 3102, i.e., a transfer rate threshold of 100 [Kbps] and a burst size threshold of 20 [Kbytes] to 1.1 times and 1.0 times of the transfer rate and burst size detected within 12 hours, respectively.

When a discarded packet is detected, it denotes that a transfer rate of 100 [Kbps] or more and/or a burst size of 20 [Kbytes] or more is detected. In this case, a value that is greater than previously is set to the transfer rate threshold and/or burst size threshold, and thus, we can make most of limited network resources.

Even in the case where an out-of-threshold does not occur, the monitoring function section 321 further instruct the control function section 331 to make automatic control every control interval specified previously (every 12 hours in any policy in the present embodiment).

The control function section 331 sets to meter 3102 the already registered values, i.e., a transfer rate threshold of 100 [Kbps] and a burst size threshold of 20 [Kbytes], to 1.1 times and 1.0 times of the bandwidth and burst size detected within such 12 hours, respectively.

At this time, if any small number of discarded packets is detected, it is presumed that a transfer rate of 100 [Kbps] or more and/or a burst size of 20 [Kbytes] or more are detected. Under such a circumference, a value greater than previously is set to the transfer rate threshold and/or burst size threshold. Thus, the policy quality is improved, and quality insufficiency is reduced.

In contrast, if a discarded packet is not detected, it is presumed that a transfer rate of 100 [Kbps] or more and a burst size of 20 [Kbytes] or more are not detected. Thus, a value smaller than previously is set to the transfer rate threshold and burst size threshold. Therefore, policy quality is lowered than currently, and excessive quality is reduced.

Operations of the other policies B, C, and Dare evident from a description of operation concerning the above described policy A. Therefore, a duplicate description is omitted here.

Although the above embodiment has described an example when the present invention is applied to “DiffServ”, the present invention is similarly applicable to “Integrated Service” (called “Intserv”) for which IETF or DMTF activelly promotes standardization without being limited thereto. In addition, apart from policy based management for primarily making packet transmission priority control or bandwidth control, the present invention is similarly applicable to policy based network management employing a firewall for making customized access control for each user, company, host, terminal, and application.

According to the present invention, the following advantageous effects are achieved.

(1) A policy enforced after distributed to each managed device (router) is dynamically adjusted according to a traffic state. Thus, the excess or insufficiency of communication quality is reduced, making it possible to efficiently use a network resource.

(2) The contents of adjustment of a policy in one managed device are synchronized with another managed device, and thus, efficiency of policy adjustment can be achieved.

What is claimed is:

1. A management device in a policy based management system for managing policy information by means of the management device, and distributing the policy information to the managed device, thereby controlling a traffic, said management device comprising:
a policy information input means for inputting policy information;
a policy evaluation information input means for inputting evaluation information for evaluating an enforcement effect of a policy in the managed device;
a policy adjustment information input means for inputting adjustment information for dynamically adjusting, a policy operated by the managed device; and
a distribution means for distributing the input policy information, policy evaluation information, and policy adjustment information to the managed device.

2. A management device in a policy based management system as claimed in claim 1, wherein said policy evaluation information contains information for judging whether or not a policy assigned to each traffic conforms to the traffic, and said policy adjustment information contains information for ensuring that a policy judged as nonconformance conforms to said traffic.

3. A management device in a policy based management system as claimed in claim 2, wherein said policy evaluation information contains information for judging whether or not a policy under operation is insufficient in resources relevant to an actual traffic, and said policy adjustment information contains information for reducing resource insufficiency of a policy.

4. A management device in a policy based management system as claimed in claim 2, wherein said policy evaluation information contains information for judging whether or not a policy under operation is insufficient in resources relevant to an actual traffic, and said policy adjustment information contains information for reducing resource excess of a policy.

5. A managed device in a policy based management system for managing policy information by means of the management device, and distributing the policy information to the managed device, thereby controlling a traffic, said managed device comprising:
a policy enforcement means for enforcing a policy information distributed from the management device, thereby controlling a traffic;
a policy evaluation means for evaluating a policy under operation based on policy evaluation information distributed from the management device; and
a policy adjustment means for dynamically adjusting a policy under operation based on the policy adjustment information distributed from the management device and the evaluation result obtained by evaluation means.

6. A managed device in a policy based management system as claimed in claim 5, wherein said policy evaluation means evaluates whether or not a policy assigned to each traffic conforms to the traffic, and said policy adjustment means ensures that the policy conforms to the traffic based on said evaluation means.

7. A managed device in a policy based management system as claimed in claim 6, wherein said policy adjustment means reduces network resources assigned by a policy evaluated as a resource excess by said evaluation means.

8. A managed device in a policy based management system as claimed in claim 6, wherein said policy adjustment means improves a quality of a policy evaluated as resource insufficiency by said evaluation means.

9. A managed device in a policy based management system as claimed in claim 5, wherein said policy adjustment means adjusts a policy assigned to each traffic in advance based on the evaluation result obtained by said evaluation means.

10. A managed device in a policy based management system as claimed in claim 5, further comprising a notifying means for notifying the policy information after adjusted to at least one of a management device and another managed device.

11. A managed device in a policy based management system as claimed in claim , where in said policy adjustment means adjusts a policy based on the notification from another managed device.
